(19) United States
(12) Patent Application Publication
(10) Pub. No.: US 2010/0039449 A1
(43) Pub. Date: Feb. 18, 2010

(54) MENU CONTROLLING METHOD

(75) Inventor: ZHAO JIN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/494,232

(22) Filed: Jun. 29, 2009

(30) Foreign Application Priority Data
Aug. 13, 2008 (CN) 200810303739.4

(51) Int. Cl. G09G 5/00

(52) U.S. Cl. 345/666; 345/173

(57) ABSTRACT

A menu controlling method implemented by a central processing unit includes displaying an original menu including menu options, receiving a touch operation, and identifying a plurality of touch points corresponding to the received touch inputs, calculating a display size of one menu option, and a covered size of an touch area formed by the touch points, calculating a ratio of the display size to the covered size, detecting whether the calculated ratio is less than a predetermined ratio, and magnifying the menu if the calculated ratio is less than a predetermined ratio.

### BACKGROUND

1. Technical Field

The disclosure relates to a menu controlling method.

2. Description of Related Art

In general, when users touch a touch screen, the touch screen senses the touch operation and pops up a menu including many menu options for user to choose. However, if the size of the menu options is too small, a user may accidentally touch two or more menu options at the same time when trying to select just one. Accordingly, the user cannot easily choose one menu option from the plurality of menu options of the menu on the touch screen.

Therefore, what is needed is a menu controlling method for easily choosing a menu option.

### BRIEF DESCRIPTION OF THE DRAWINGS

FIG. 1 is a flowchart of a menu controlling method implemented by a central processing unit (CPU) of an electronic device in accordance with one embodiment.

FIG. 2 is a diagram of a menu referred to in FIG. 1 in an unmagnified state in accordance with one embodiment.

FIG. 3 is a diagram of the menu of FIG. 2 in a magnified state in accordance with one embodiment.

### DETAILED DESCRIPTION

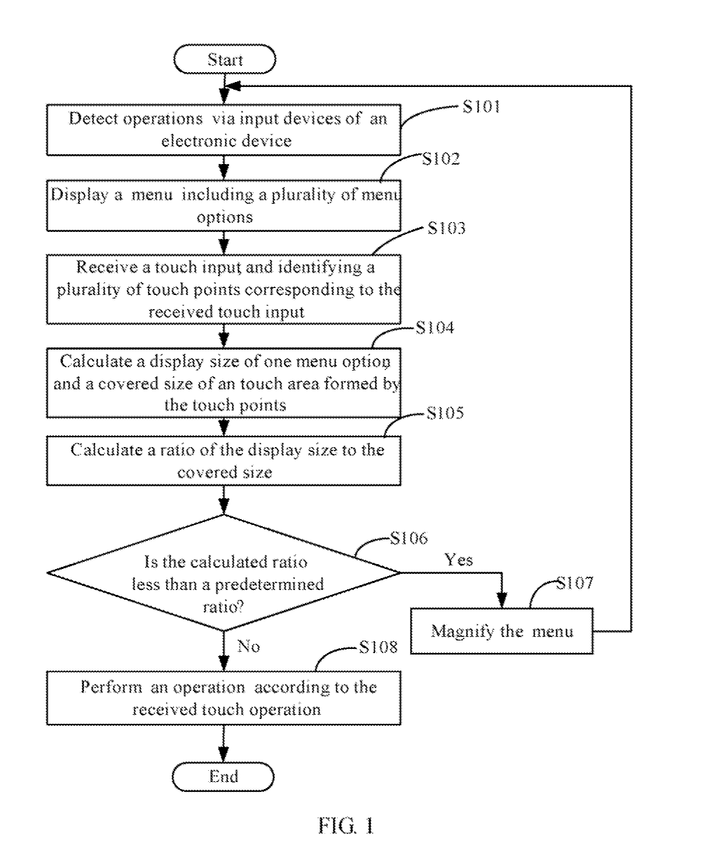

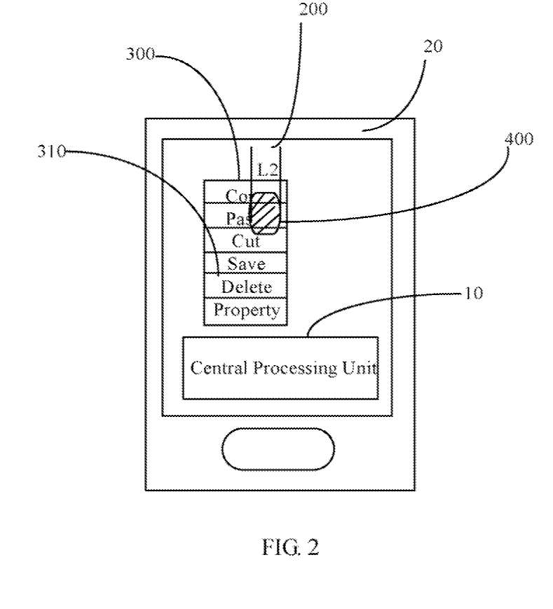

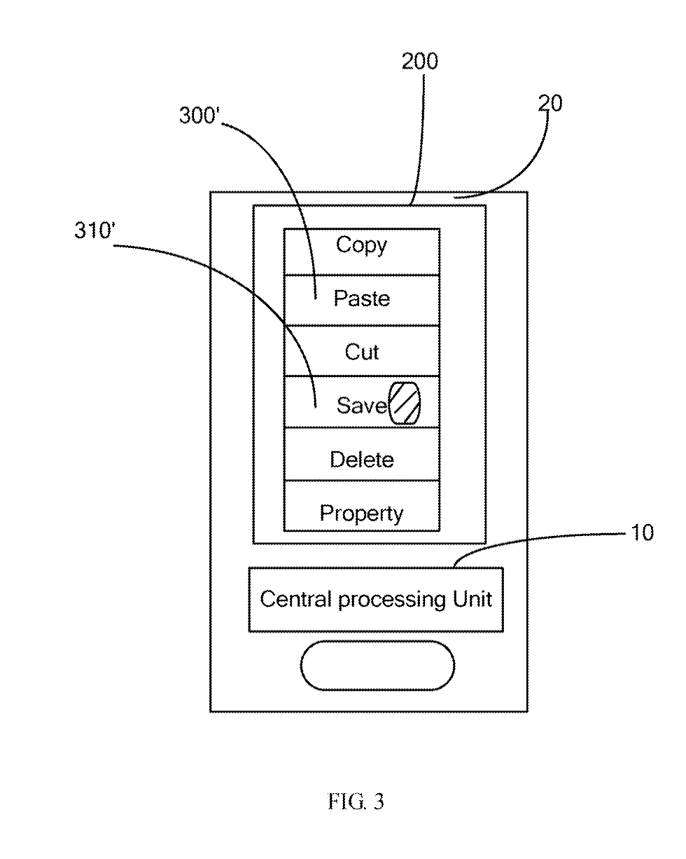

FIG. 1 is a flowchart of a menu controlling method implemented by a CPU 10 (shown in FIG. 2) of an electronic device 20 (shown in FIG. 2) in accordance with one embodiment. FIG. 2 is a diagram of a menu 300 referred to in FIG. 1 in an unmagnified state in accordance with one embodiment. FIG. 3 is a diagram of the menu 300 of FIG. 2 in a magnified state in accordance with one embodiment. FIG. 2 and FIG. 3 will be described together with FIG. 1 in the following disclosure.

In step S101, the CPU 10 of the electronic device 20 detects operations from users via input devices (not shown) of the electronic device 20, such as a touch pen, mouse, or a finger.

In step S102, the CPU 10 displays the menu 300 including a plurality of menu options 310 according to the operations on a touch screen 200 of the electronic device 20 after the CPU 10 detects the operations. The menu 300 corresponds to one or more programs stored in the storage system. Dimensions of the menu options 310 and touched areas of the touch screen 200 used for calculations in the menu controlling method may include one or a combination of area, length, and height. As shown in FIG. 2, a menu 300 is displayed in the touch screen 200 of the electronic device 20, and the menu 300 includes a plurality of menu options 310 having the same size, such as: copy, paste, cut, and so on.

In step S103, the CPU 10 receives a touch input via the input device on the touch screen 200, and identifies a plurality of touch points corresponding to the touch input. As shown in FIG. 2, the CPU 10 receives a touch input, and identifies a plurality of touch points forming a touch area 400 corresponding to the touch operation.

In step S104, the CPU 10 calculates a display size of one menu option 310, and a covered size of the touch area 400 formed by the touch points. Dimensions of the display size of the menu option 310 for calculations in the menu controlling method may include one or a combination of display area, display length, and display height. In one embodiment, the CPU 10 calculates the display area according to a length and a height of the menu option 310. If the size of the menu option 310 covered by the touch operation is different, the CPU 10 chooses a larger size menu option from the covered menu options to calculate the display size. The CPU 10 calculates the covered size of the touch area 400 according to a number of touch points. Dimensions of the covered size of the touch area 400 for calculations in the menu controlling method may include one or a combination of covered area, covered length, and covered height, which corresponds to the display size of the menu option.

In step S105, the CPU 10 calculates a ratio of the display size to the covered size. For example, the calculated ratio may be a ratio of the display area to the covered area, a ratio of the display length to the covered length, and a ratio of the display height to the covered height.

In step S106, the CPU 10 detects whether the calculated ratio is less than a predetermined ratio; if so, the method continues to step S107. If not, the method returns to step S108.

In step S107, the CPU 10 magnifies the menu 300 according to the ratio of the display size to the covered size, and goes to step S101.

In step S108, the CPU 10 performs an operation according to the received touch input. As shown in FIG. 2, there are three menu options 310 covered by the touch points corresponding to the touch operation. Thus the CPU 10 cannot determine which menu option is being chosen from the three menu options 310. As shown in FIG. 3, the menu 300 is automatically magnified to a larger menu 300′. Accordingly, the menu options 310 are magnified and to larger menu options 310′.

Although the present disclosure has been specifically described on the basis of the embodiments thereof, the disclosure is not to be construed as being limited thereto. Various changes or modifications may be made to the embodiment without departing from the scope and spirit of the disclosure.

What is claimed is:

1. A computer-implemented method for operating a touch screen, the method comprising:
providing an electronic device, the electronic device comprising a touch screen, a central processing unit (CPU), a storage system comprising one or more programs to be executed by the CPU;
displaying a menu corresponding to the one or more programs, the menu including a plurality of menu options on the touch screen;
receiving touch inputs via an input device on the touch screen, and identifying a plurality of touch points corresponding to the received touch inputs;
calculating a display size of one menu option and a covered size of a touch area formed by the touch points;
calculating a ratio of the display size to the covered size; and
magnifying the menu according to the ratio of the display size to the covered size if the calculated ratio is less than a predetermined ratio.

2. The method as described in claim 1, further comprising:
performing an operation on the menu according to the received touch inputs if the calculated ratio is not less than a predetermined ratio.

3. The method as described in claim 1, further comprising:
calculating the covered size of the touch area formed by the touch points according to a number of the touch points.

4. The method as described in claim 1, wherein the covered size is corresponding to the display size.

5. The method as described in claim 1, wherein dimensions of the menu options and touched areas of the touch screen used for calculations in the menu controlling method comprises one or a combination of area, length, and height.

6. The method as described in claim 5, wherein dimensions of the display size of the menu option for calculations in the menu controlling method comprises one or a combination of display area, display length, and display height.

7. The method as described in claim 5, wherein dimensions of the covered size of the touch area for calculations in the menu controlling method comprise one or a combination of covered area, covered length, and covered height.

8. The method as described in claim 5, wherein the calculated ratio is a ratio of the display area to the covered area.

9. The method as described in claim 5, wherein the calculated ratio is a ratio of the display length to the covered length.

10. The method as described in claim 5, wherein the calculated ratio is a ratio of the display height to the covered height.

11. The method as described in claim 5, wherein the calculated ratio is a ratio of the display area to the covered area, a ratio of the display length to the covered length, or a combination thereof.

12. The method as described in claim 5, wherein the calculated ratio is a ratio of the display area to the covered area, a ratio of the display height to the covered height, or a combination thereof.

13. The method as described in claim 5, wherein the calculated ratio is a ratio of the display length to the covered length, a ratio of the display height to the covered height, or a combination thereof.

14. The method as described in claim 5, wherein the calculated ratio is a ratio of the display area to the covered area and a ratio of the display length to the covered length, a ratio of the display height to the covered height, or a combination thereof.

15. The method as described in claim 5, wherein the calculated ratio is a ratio of the display area to the covered area and a ratio of the display height to the covered height, a ratio of the display length to the covered length, or a combination thereof.
